(19) United States
(12) Patent Application Publication
(10) Pub. No.: US 2002/0198946 A1
(43) Pub. Date: Dec. 26, 2002

(54) Personal centralized alert delivery systems and methds of use

(76) Inventors: Yi-Min Wang, Bellevue, WA (US); Paramvir Bahl, Issaquah, WA (US); Wilf G. Russell, Redmond, WA (US)

Correspondence Address: LEE & HAYES PLLC, 421 W RIVERSIDE AVENUE SUITE 500, SPOKANE, WA, 99201

(21) Appl. No.: 09/887,413

(22) Filed: Jun. 21, 2001

Related U.S. Application Data
(60) Provisional application No. 60/262,089, filed on Jan. 16, 2001.

(51) Int. Cl. G06F 15/16

(52) U.S. Cl. 709/206

(57) ABSTRACT

A centralized alert delivery system receives alerts for its subscribers from various alert sources. It categorizes these alerts according to the source of the alert or the content of the alert. Subscribers pre-specify delivery modes for each of the alert categories they are interested in. The delivery mode includes one or more delivery, blocks which in turn include one or more delivery actions. Delivery actions specify a delivery method, whether an acknowledgement to the alert is expected, and a time to wait for the acknowledgement. When the delivery mode contains more than one delivery block, then these delivery blocks are ranked designated as primary, secondary, and tertiary according to the subscriber's preference. The delivery method may be e-mail, instant messaging or short message system (SMS) messaging. An attempt is made to deliver the alert via the delivery actions indicated in the primary delivery block. If the alert is successfully delivered, the process terminates. If the alert delivery is encounters an error, the alert is delivered via one or more delivery actions indicated by a secondary delivery block, if a secondary delivery block has been identified for the alert category.

### RELATED APPLICATION

This non-provisional utility application claims priority to the provisional application No. 60/262,089 entitled “Centralized Alert Delivery Systems and Methods of Use,” filed on Jan. 16, 2001.

### TECHNICAL FIELD

The systems and methods described herein relate generally to alert delivery systems and, more particularly, to centralized alert delivery systems and methods for use.

### BACKGROUND

The explosive growth of the Internet has created a gigantic networked data store that contains a wealth of information for immediate access by anyone with a computer having an Internet connection. However, such high availability of potentially useful information has also created information overflow problems for individuals. One way that has begun to alleviate the information overflow has been to change the data access model from information polling and navigation (i.e., surfing the Web) to an event driven model, or alerting.

An alert is an electronic transmission, or delivery, of user-subscribed information to a user. Instead of browsing through many Web sites in which a user may be interested, the user may instead register, or subscribe, to a service to receive alerts upon the occurrence of certain events. As part of the registration process, the user specifies an e-mail address to which alerts should be sent.

Several sites provide general alerts for stock quotes, weather, sports, lottery, career services, real estate, etc. Specialized sites may provide more specific alerts. For example, an on-line financial services provider may provide a periodic alert of a user's stock positions, or alerts to users whenever a stock price reaches a certain level. A sports information provider may send an alert containing a score from a game in which the user has indicated an interest. A consumer products provider may alert subscribers when a price on certain items decreases or reaches a specified limit. The number of scenarios in which alerts may be desired is virtually limitless.

Several types of other alerts are also emerging. Online communities services allow users from different parts of the world who share similar interests to create virtual communities. Members of such a community can share photographs, activity calendars, etc. in a password-protected private area. It would be desirable to let these members subscribe to alerts that are triggered by changes made to relevant community contents.

Another example of where an alert system would be useful is a home networking system. Home networking solutions that connect diverse sets of devices and sensors via heterogeneous in-home networks attaching them to the Internet could include the ability to send alerts to subscribers whenever a critical sensor is activated or whenever a critical device experiences problems. For instance, if a sensor determines that an intruder has entered the home, an alert could issue notifying the homeowner and the local police. Similarly, if a refrigerator in such a system fails and the failure is detected, the homeowner could be notified so that appropriate timely action can be taken. In both cases, alert notification has to happen quickly. Intruder-detection notification has to be delivered quickly, and if the refrigerator fails at 10:00 a.m. on a typical workday, the owner must be notified quickly and a repairman called. Otherwise, the homeowner may not discover the problem until the evening, when it is too late or more expensive to call a repairman.

Location-aware systems that are used to track users and inform users of the locations of network resources or other users, could integrate an alert system to notify an authorized subscriber when another user enters a certain area, such as a building in which the subscriber is located.

Desktop assistant software that is used to help users organize tasks would benefit from an alert system that recognizes important e-mails or detects important reminders while the user is away.

The current model of alert subscription and delivery has several dependability-related problems. First, most of the alerts today are delivered as e-mail messages, which are not suitable for delivering time-critical, high-importance alerts. Second, alert users usually require different timeliness and reliability levels for different categories of alerts. Most of today's alert services do not provide customizability at this finer granularity. Third, the above requirements may change over time. Since alerts from multiple sources may belong to the same category, having to visit multiple Web sites to modify or disable alert delivery mechanisms is a cumbersome task that greatly impacts the usability of alert services. Finally, to receive alerts as SMS (Short Message Service) messages on a cellular telephone, a user must supply the user's SMS e-mail address. Since the SMS e-mail address typically contains the corresponding cell phone number, providing this information to multiple alert services can create serious privacy concerns.

Another problem encountered with current alert systems is that they do not take into account system failures or other problems that may arise to prevent the delivery of an alert. This is a problem that can obviously be alleviated to some degree through redundant transmission of alerts. For example, each alert could be delivered as n duplicate e-mail messages and m duplicate SMS messages. However, such extreme redundancy would make the alert system irritating and cumbersome for practically use. The human factor must be assessed in deriving the appropriate trade-off between timeliness/reliability and usability.

### SUMMARY

A personalized centralized alert delivery system is described that addresses the issues previously discussed. To support delivery of time-critical, high-importance alerts, instant messaging (IM) with user acknowledgement is utilized. This provides end-to-end synchronous, reliable delivery of alerts. Like e-mail messaging, instant messaging is becoming another standard way of communication over the Internet for people to exchange short, fast messages. The implementations described herein extend the use of instant messaging to communications between potentially non-human entities.

Multiple delivery modes are utilized to support personalized dependability requirements for alert delivery. Each delivery mode involves potentially multiple addresses to accommodate communication delays and failures. A user defines his or her own set of delivery modes, each of which corresponds to a personalized dependability level. For example, a user might have delivery modes available for e-mail messages, instant messages and SMS messages. Some delivery modes may be used more often than others or only in particular instances.

Each user in the system has an alert center that is always online for receiving and acknowledging IM-alerts and has at least one e-mail address as a fallback mechanism. The alert center allows each user to easily customize the delivery system to suit the user's needs. All alerts are first directed to the alert center, which then determines the best way at that time to route the alerts to the user, based on the user's static and dynamic preference of dependability. Since only the address or addresses of the alert center are revealed to the various alert sources, the user's privacy is greatly enhanced.

Implementations are also described that incorporate extensive fault-tolerance mechanisms into the alert center to avoid a single point of failure. Exception handling is automated to enhance the robustness of applications that drive the IM and e-mail communication client software.

### BRIEF DESCRIPTION OF THE DRAWINGS

FIG. 1 is a block diagram of an exemplary computer system on which the described invention(s) may be implemented.

FIG. 2 is a block diagram of a prior art alert delivery system.

FIG. 3 is a block diagram of a centralized alert delivery system.

FIG. 4 is a block diagram of a computer implementing an alert center program.

FIG. 5 is a diagram of a delivery action used in an alert center program.

FIG. 6 is a diagram of a category used in an alert center program.

FIG. 7 is a block diagram of a user address module as used in one implementation of an alert center program described herein.

FIG. 8 is a block diagram of a mapping module as used in one implementation of an alert center program described herein.

FIG. 9 is a block diagram of a delivery modes module as used in one implementation of an alert center program described herein.

FIG. 10 is a block diagram of a categories module as used in one implementation of an alert center program described herein.

FIG. 11 is a flow diagram depicting configuration of an alert center system.

FIG. 12 is a flow diagram depicting a method for receiving and distributing alerts.

### DETAILED DESCRIPTION

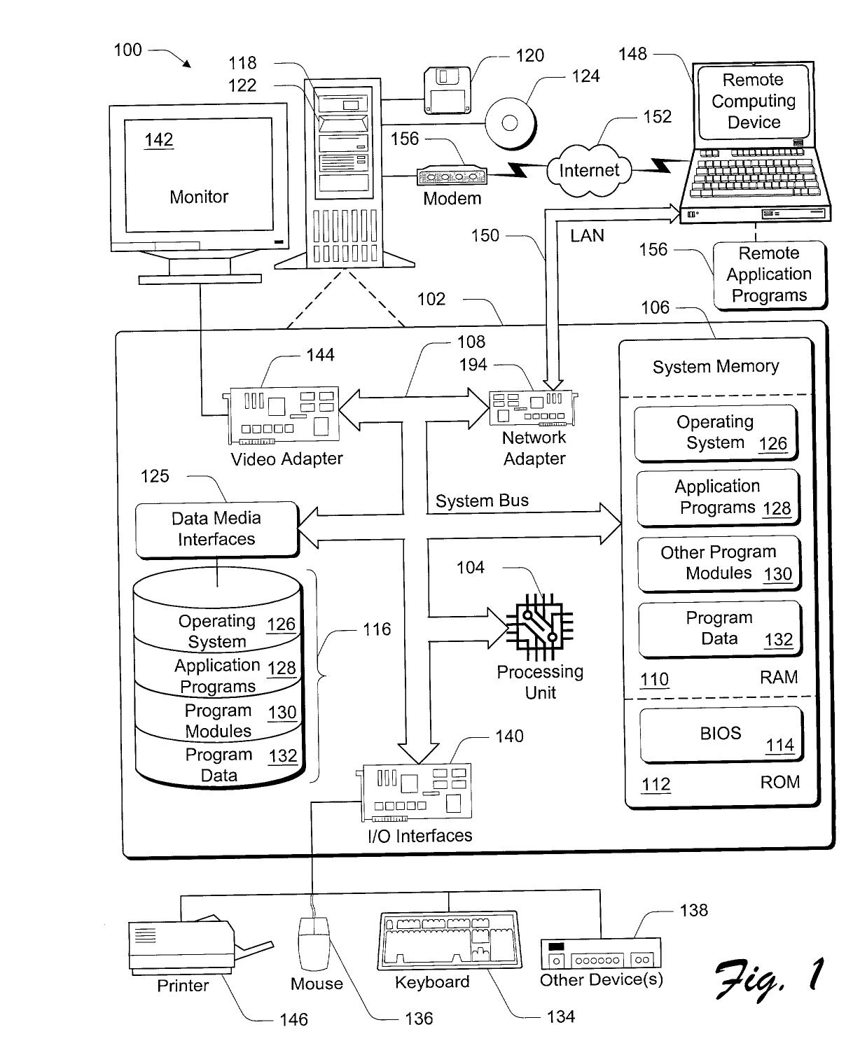

FIG. 1 illustrates an example of a suitable computing environment 100 within which a centralized alert delivery system as described herein, may be implemented (either fully or partially). The computing environment 100 may be utilized in the computer and network architectures described herein.

The exemplary computing environment 100 is only one example of a computing environment and is not intended to suggest any limitation as to the scope of use or functionality of the computer and network architectures. Neither should the computing environment 100 be interpreted as having any dependency or requirement relating to any one or combination of components illustrated in the exemplary computing environment 100.

The centralized alert delivery system may be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The centralized alert delivery system may be described in the general context of computer-executable instructions, such as program modules, being executed by a computer. Generally, program modules include routines, programs, objects, components, data structures, etc. that perform particular tasks or implement particular abstract data types. The centralized alert delivery system may also be practiced in distributed computing environments where tasks are performed by remote processing devices that are linked through a communications network. In a distributed computing environment, program modules may be located in both local and remote computer storage media including memory storage devices.

The computing environment 100 includes a general-purpose computing device in the form of a computer 102. The components of computer 102 can include, by are not limited to, one or more processors or processing units 104, a system memory 106, and a system bus 108 that couples various system components including the processor 104 to the system memory 106.

The system bus 108 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 102 typically includes a variety of computer readable media. Such media can be any available media that is accessible by computer 102 and includes both volatile and non-volatile media, removable and non-removable media.

The system memory 106 includes computer readable media in the form of volatile memory, such as random access memory (RAM) 110, and/or non-volatile memory, such as read only memory (ROM) 112. A basic input/output system (BIOS) 114, containing the basic routines that help to transfer information between elements within computer 102, such as during start-up, is stored in ROM 112. RAM 110 typically contains data and/or program modules that are immediately accessible to and/or presently operated on by the processing unit 104.

Computer 102 may also include other removable/non-removable, volatile/non-volatile computer storage media. By way of example, FIG. 1 illustrates a hard disk drive 116 for reading from and writing to a non-removable, non-volatile magnetic media (not shown), a magnetic disk drive 118 for reading from and writing to a removable, non-volatile magnetic disk 120 (e.g., a “floppy disk”), and an optical disk drive 122 for reading from and/or writing to a removable, non-volatile optical disk 124 such as a CD-ROM, DVD-ROM, or other optical media. The hard disk drive 116, magnetic disk drive 118, and optical disk drive 122 are each connected to the system bus 108 by one or more data media interfaces 125. Alternatively, the hard disk drive 116, magnetic disk drive 118, and optical disk drive 122 can be connected to the system bus 108 by one or more interfaces (not shown).

The disk drives and their associated computer-readable media provide non-volatile storage of computer readable instructions, data structures, program modules, and other data for computer 102. Although the example illustrates a hard disk 116, a removable magnetic disk 120, and a removable optical disk 124, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 116, magnetic disk 120, optical disk 124, ROM 112, and/or RAM 110, including by way of example, an operating system 126, one or more application programs 128, other program modules 110, and program data 132. Each of such operating system 126, one or more application programs 128, other program modules 130, and program data 132 (or some combination thereof) may include an embodiment of a communications layer and a subscription layer of the centralized alert delivery system.

A user can enter commands and information into computer 102 via input devices such as a keyboard 134 and a pointing device 136 (e.g., a “mouse”). Other input devices 138 (not shown specifically) may include a microphone, joystick, game pad, satellite dish, serial port, scanner, and/or the like. These and other input devices are connected to the processing unit 104 via input/output interfaces 140 that are coupled to the system bus 108, but may be connected by other interface and bus structures, such as a parallel port, game port, or a universal serial bus (USB).

A monitor 142 or other type of display device can also be connected to the system bus 108 via an interface, such as a video adapter 144. In addition to the monitor 142, other output peripheral devices can include components such as speakers (not shown) and a printer 146 which can be connected to computer 102 via the input/output interfaces 140.

Computer 102 can operate in a networked environment using logical connections to one or more remote computers, such as a remote computing device 148. By way of example, the remote computing device 148 can be a personal computer, portable computer, a server, a router, a network computer, a peer device or other common network node, and the like. The remote computing device 148 is illustrated as a portable computer that can include many or all of the elements and features described herein relative to computer 102.

Logical connections between computer 102 and the remote computer 148 are depicted as a local area network (LAN) 150 and a general wide area network (WAN) 152. Such networking environments are commonplace in offices, enterprise-wide computer networks, intranets, and the Internet.

When implemented in a LAN networking environment, the computer 102 is connected to a local network 150 via a network interface or adapter 154. When implemented in a WAN networking environment, the computer 102 typically includes a modem 156 or other means for establishing communications over the wide network 152. The modem 156, which can be internal or external to computer 102, can be connected to the system bus 108 via the input/output interfaces 140 or other appropriate mechanisms. It is to be appreciated that the illustrated network connections are exemplary and that other means of establishing communication link(s) between the computers 102 and 148 can be employed.

In a networked environment, such as that illustrated with computing environment 100, program modules depicted relative to the computer 102, or options thereof, may be stored in a remote memory storage device. By way of example, remote application programs 158 reside on a memory device of remote computer 148. For purposes of illustration, application programs and other executable program components such as the operating system are illustrated herein as discrete blocks, although it is recognized that such programs and components reside at various times in different storage components of the computing device 102, and are executed by the data processor(s) of the computer.

Computer-executable Instructions

An implementation of a centralized alert delivery system may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Exemplary Operating Environment

FIG. 1 illustrates an example of a suitable operating environment 100 in which a centralized alert delivery system may be implemented. Specifically, the centralized alert delivery system(s) described herein may be implemented wholly or in part by any program modules 128-130 and/or operating system 126 in FIG. 1 or a portion thereof.

The operating environment is only an example of a suitable operating environment and is not intended to suggest any limitation as to the scope or use of functionality of the centralized alert delivery system(s) described herein. Other well known computing systems, environments, and/or configurations that are suitable for use include, but are not limited to, personal computers (PCs), server computers, hand-held or laptop devices, multiprocessor systems, microprocessor-based systems, programmable consumer electronics, wireless phones and equipments, general- and special-purpose appliances, application-specific integrated circuits (ASICs), network PCs, minicomputers, mainframe computers, distributed computing environments that include any of the above systems or devices, and the like.

Computer Readable Media An implementation of a centralized alert delivery system may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

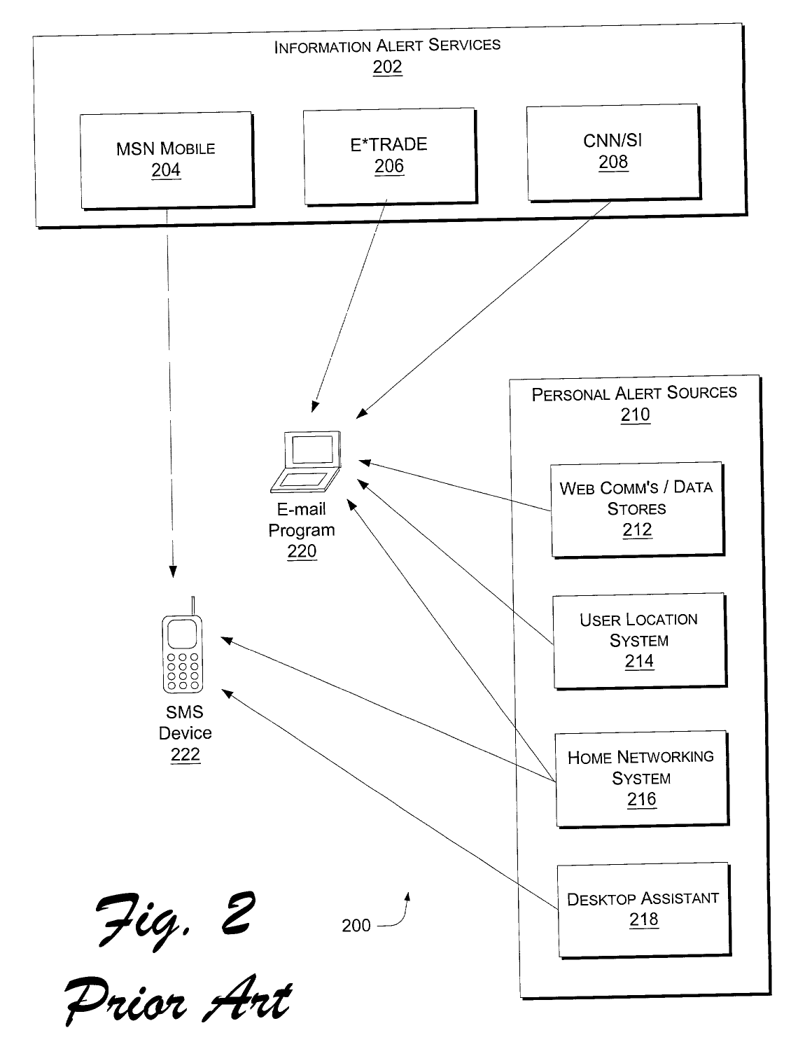

FIG. 2 is a block diagram of a prior art alert delivery system 200. The system 200 includes information alert services 202, in this example MSN MOBILE 204, E*TRADE 206 and CNN/SI 208. The system 200 also includes personal alert sources 210, for example, Web communities/data stores 212, a user location system 214, a home networking system 216 and a desktop assistant 218. Alerts are sent to an e-mail program 220 on a computing device or an SMS device 222.

In the system shown in FIG. 2, a user (the owner of the e-mail program 220 and the SMS device 222) visits each individual service or site shown and enters subscriptions based on categories, keywords, etc. The user also supplies an e-mail address and/or an SMS address to which the alerts should be sent. When a service detects an alert that fits the user's description, the alert is sent to the address indicated by the user at that particular service.

The user can thereby control the content of alerts that will be sent to the user. Furthermore, the user is able to control where alerts of particular content are sent. However, if the user adds an additional address for alert delivery or if the user changes or removes an existing address, the user must go back to each alert source and update the information. In addition, the user is not provided a high degree of reliability with this system because, for example, if the user registers with an alert source to send alerts to a work e-mail address, then the user may not receive those alerts if the user is away from work for an extended period of time. By the time the user gets those alerts, the information will be stale.

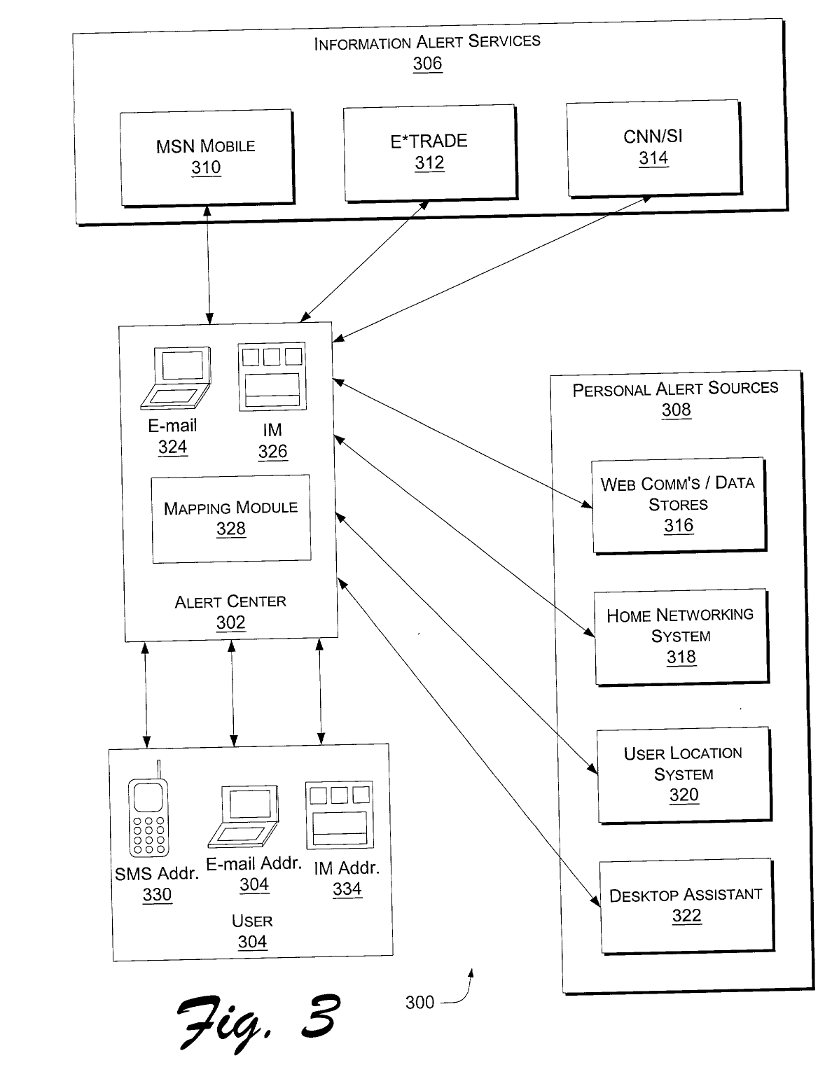

FIG. 3 is a block diagram of a centralized alert delivery system 300 that includes an alert center 302, a user 304, information alert services 306 and personal alert sources 308. The information alert services 306 are services that provide information to browsers on the Internet and are similar to those shown in FIG. 2. By way of example, the information alert services shown are MSN MOBILE 310, E*TRADE 312 and CNN/SI 314. The personal alert sources 308 are Web communities/data stores 316, a home networking system 318, a user location system 320 and a desktop assistant 322.

The alert center 302 includes an e-mail program 324, an IM program 326 and a mapping module 328. The e-mail program and the IM program 326 are configured to receive e-mail alerts and IM alerts, respectively, from the information alert services 306 and the personal alert sources 308. The mapping module 328 is configured by the user 304 to direct alerts received from various sources to an SMS address 330, an e-mail address 332 and/or an IM address 334. It is noted that, although SMS messaging is used in the present example, any other type of messaging may be used in combination with or instead of SMS messaging. SMS messaging is only exemplary in this particular example.

In one implementation, the user 304 designates alert sources as being in certain categories in the mapping module 328. For example, there may be a category for financial alerts, a category for news, a category for sales, etc. The user 304 assigns a delivery method for this category (SMS, e-mail, IM) according to the importance of the alert. Alerts that the user 304 wants to receive right away will be designated to be sent to the IM address 334 or the SMS address 330. Other important, but not critical, alerts may be designated to be sent to the e-mail address 332. It is noted that there may be multiple delivery methods (e.g., Instant Messaging, SMS Messaging and/or e-Mail) assigned to a category. In such case, one delivery method is designated as a primary delivery method and another delivery method is designated as a secondary, or backup, delivery method. Furthermore, a third delivery method, if designated, is designated as a tertiary delivery method. If the primary delivery method is unavailable or fails to deliver the alert, the alert is delivered via the secondary delivery method, and so on. For example, if an alert category designates IM as the primary delivery method and e-mail as the backup delivery method, then the alert is delivered via Instant Messaging. However, if the user is not available for IM or the alert fails to be delivered via IM, then the alert is delivered by e-mail.

To provide greater reliability, the centralized alert delivery system 300 is configured to use acknowledgements tagged with IM message sequence numbers to verify that the user 304 has obtained an alert. This is an improvement over existing IM messaging services that gives hints as to whether a user (receiver) is on the other end of a communication and is able to see and respond to an incoming IM message. Typically, if a user logged on to an IM service is actively using a machine, then the user's state is shown as “online” to other users. If the user leaves the machine idle for a period of time that is longer than an idle threshold, the user's state would be changed to “away.” Instead of relying on such presence information to determine whether synchronous, reliable communication can be performed successfully, the centralized alert delivery system 300 requires explicit acknowledgement from the user to confirm end-to-end reliability of any alert.

This is because the user in the above example may have just left the machine but the user's “online” state has not yet changed. On the other hand, the user may at the machine, ready to receive IM messages, but the user's state has been changed to “away” because the user has not touched the machine for awhile. Similar problems with using presence information exist in cellular telephone technology, where a user may have turned on a cell phone but left it in a car. Or, the user may have left the phone turned off but will turn it on shortly to check for messages. Such presence information can only serve as hints because the user may be separated from devices and because such information is always potentially stale.

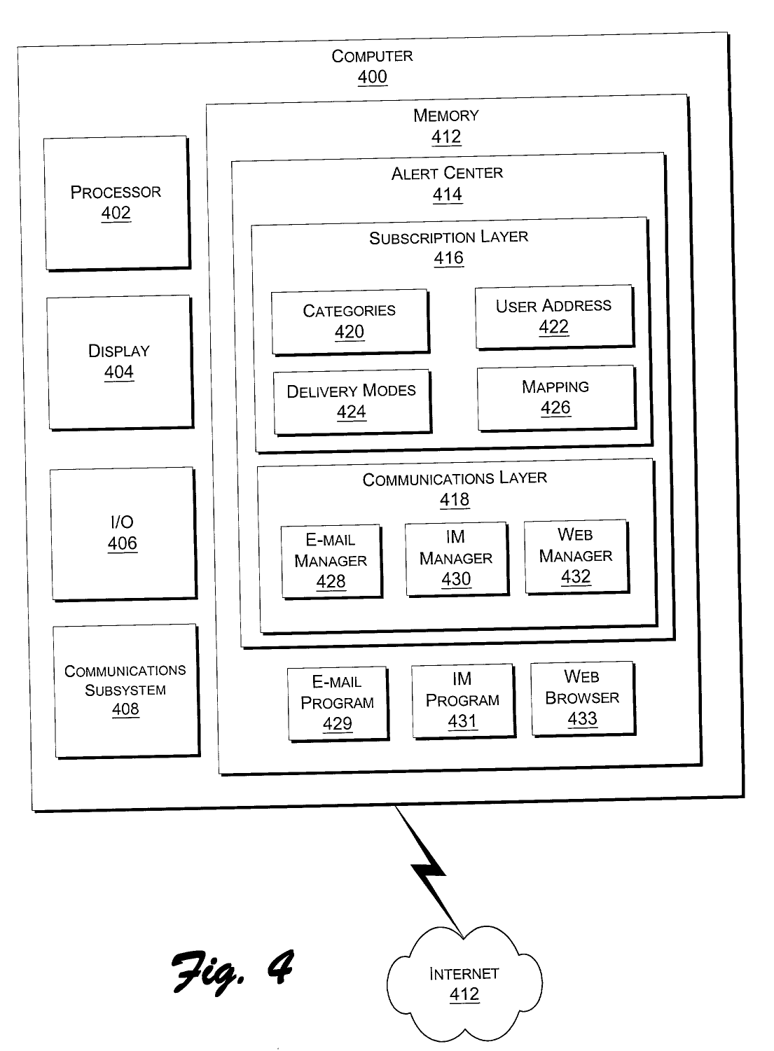

FIG. 4 is a block diagram of a computer 400 that implements a centralized alert delivery system. The computer 400 includes a processor 402, a display 404, an input/output (I/O) module 406 through which data can be entered by a user, and a communications subsystem 408 that enables the computer 400 to communicate with the Internet 410. The computer 400 also includes memory 412 that stores an alert center program 414. The alert center program 414 has a subscription layer 416 and a communications layer 418.

The subscription layer 416 has a categories module 420 that allows a user to register alert categories and their characteristics. A user address module 422 provides an application program interface for a user to register addresses for alert delivery. The subscription layer 416 also includes a delivery modes module 424 wherein a user can enter personal delivery modes that the user wishes to use. A mapping module 426 provides a way to map a category with one or more modes of delivery.

In a preferred implementation, user addresses and delivery modes are expressed in Extensible Markup Language (XML) to allow extensibility for accommodating new communication addresses. An XML document for user addresses consists of a list of all of a user's addresses at which the user may be willing to receive alerts. Each address is associated with a communication type, e.g., “IM,” “SMS,” “EM”) and identified by a friendly name such as “MSN IM,” “Hotmail,” “AT&T Text Messaging,” etc. An XML document for a delivery mode contains one or more delivery blocks, each of which contains one or more delivery actions. Each delivery action maps to the friendly name of an address.

The communications layer 418 includes an e-mail manager 428, an IM client 430 and a browser manager 432. The communications layer 418 provides interfaces for programmatically performing Internet communications that are usually performed by humans. The e-mail manager 428 encapsulates all interactions with an e-mail program 429 that supports Component Object Model (COM) automation interfaces. The e-mail manager 428 provides interfaces for sending and receiving e-mails, retrieving reminders, subscribing to new email and new reminder events, etc. The browser manager 432 interacts with a Web browser 433 through the browser's automation interfaces and exposes interfaces for sending URL (Universal Resource Locator) requests and processing returned HTML (Hypertext Markup Language) files.

The IM manager 430 drives an IM program 431 through automation interfaces to perform IM operations. The IM manager 430 provides interfaces for sending and receiving IM messages, extracting a contact list, obtaining address information and online state of each contact, subscribing to new IM events, etc. To address the issues of lost and duplicated IM messages, each IM and acknowledgement is tagged with a message sequence number. If a sender invokes the IM-with-acknowledgement interface and no acknowledgement of the matching sequence number is received within a sender-specified time period, the send call is failed. In one implementation, this failure triggers a backup delivery mechanism in the delivery modes module 424 and fallback to either e-mail or SMS.

FIG. 5 is a diagram of a delivery action 500 used in an alert center program similar to the alert center 414 of FIG. 4. The delivery action 500 includes a delivery method field 502 which identifies the method by which an alert associated with the delivery action 500 will be delivered, such as Instant Messaging, SMS Messaging, E-Mail, etc. The delivery action 500 also includes an acknowledgement field 504 that indicates whether an acknowledgement indicating that the alert was received should be expected by the alert center program. If the acknowledgement field 504 indicates that an acknowledgement signal is to be expected, a time to wait field 506 included in the delivery action 500 is set to a time value. If an acknowledgement is not received within the time specified in the time to wait field 506, then the alert delivery is considered to have failed.

Further discussion of delivery actions 500, including uses and examples will be presented below with reference to following figures.

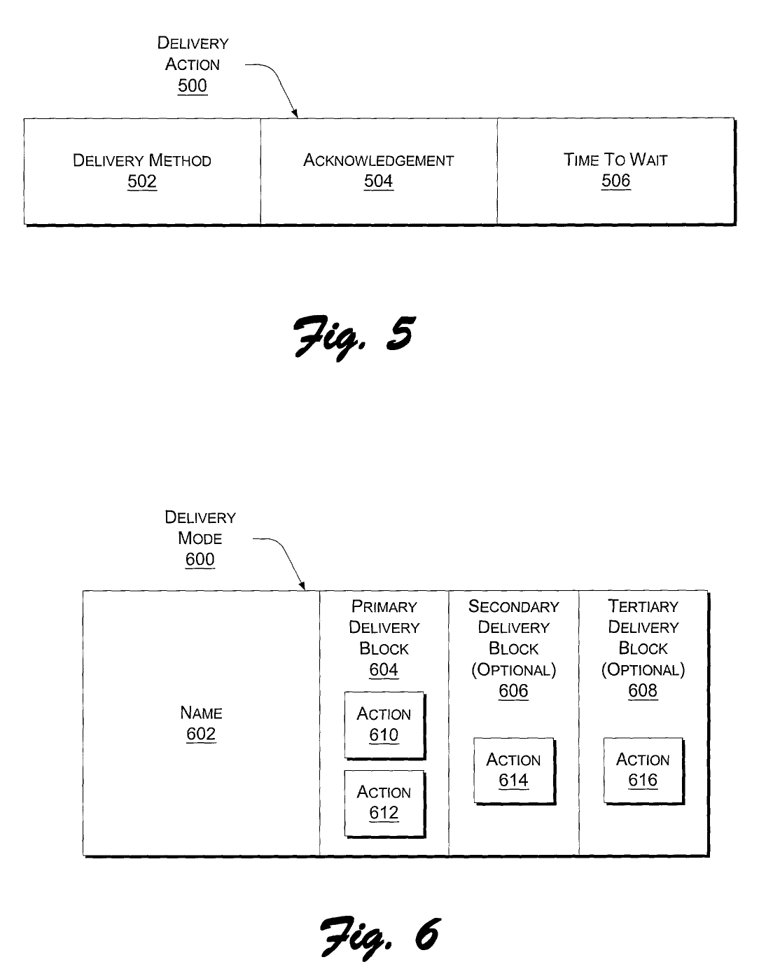

FIG. 6 is a diagram of a delivery mode 600 that includes a delivery mode name 602 that is used to identify the delivery mode 600. The delivery mode 600 also includes a primary delivery block 604, which includes two delivery actions, delivery action 610 and delivery action 612. When an alert is associated with the delivery mode 600, the alert is delivered according to each delivery action 610, 612 specified in the primary delivery block 604 of the delivery mode 600. For example, delivery action 610 may specify a delivery method of Instant Messaging, and delivery action 612 may specify a delivery method of E-Mail. In such a case, the alert would be delivered by both IM and E-Mail.

The delivery mode 600 also includes a secondary delivery block 606 and a tertiary delivery block 608. The secondary delivery block 606 includes delivery action 614 and the tertiary delivery block 608 includes delivery action 616. Both the secondary delivery block 606 and the tertiary delivery block 608 are optional. It is noted that from one to as many delivery blocks as desired by the user may be included in the category 600. However, three delivery blocks 604-608 are shown here for discussion purposes.

If the alert delivery according to the delivery actions 610, 612 of the primary delivery block 604 fails, then the alert is delivered according to the delivery action 614 designated in the secondary delivery block 606 (if a secondary delivery block is present). Likewise, if the alert fails to be delivered according to the secondary delivery block 606, then the alert is delivered according to the delivery mode 616 of the tertiary delivery block 608. Furthermore, according to one implementation that will be discussed in greater detail below, if the primary delivery block 604 includes more than one delivery action 610, 612, then the primary delivery block 604 will be considered to have failed—thus triggering the secondary delivery block 606—if either/any of the delivery actions 610, 612 of the primary delivery block 604 fails. For example, if the primary delivery block 604 includes a first delivery action that indicates an alert is to be transmitted by Instant Messaging and a second delivery action that indicates the alert is also to be transmitted by E-Mail, then the primary delivery block 604 will be deemed to have failed if either the IM or the EM fails. In such a case, the delivery action(s) of the secondary delivery block 606 will be activated. Likewise, if one or more of the delivery actions of the secondary delivery block 606 fail, then the alert will be delivered according to the delivery action(s) of the tertiary delivery block 608.

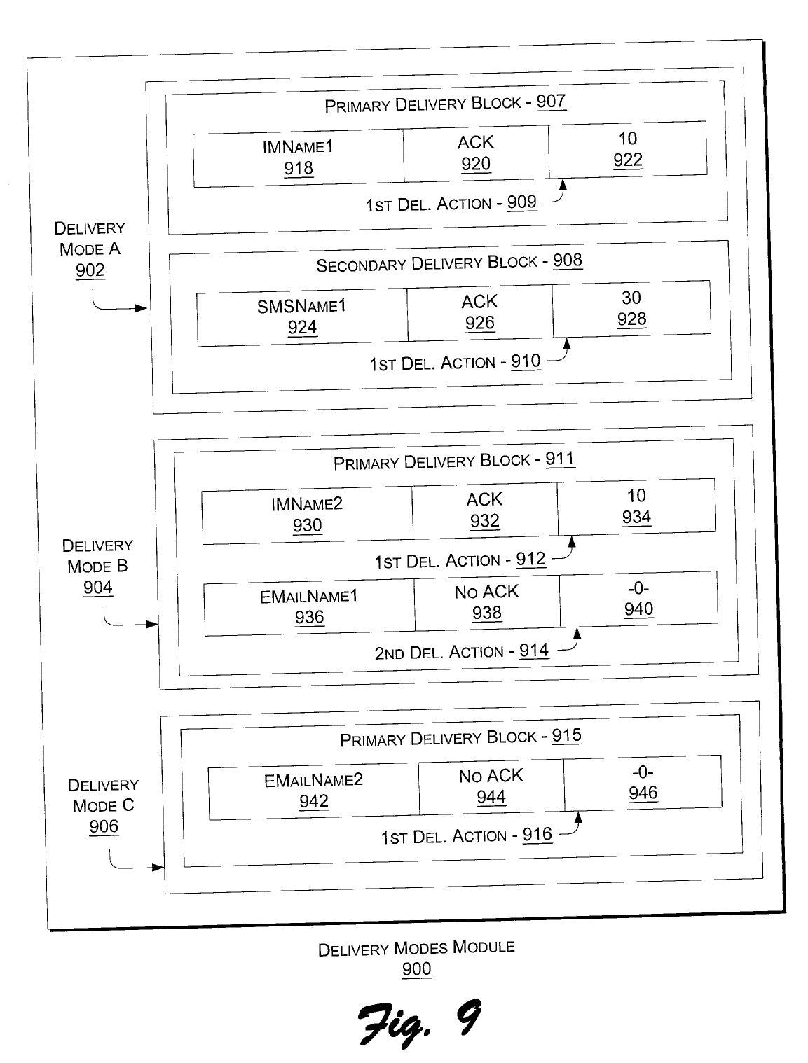

Illustrations 1a, 1b and 1c show sample delivery mode documents. The XML delivery mode documents shown in Illustrations 1a, 1b and 1c correspond to the delivery modes module 900 shown in FIG. 9. When a native alert arrives, the subscriptions of the matching category are identified and the corresponding delivery mode XML documents are parsed. Only actions that map to enabled addresses at that time are performed.

<comm. mode>

<comm._block>

<comm._action>

<name>IMName1</name>
<ack_mode>yes</ack_mode>
<ack_time>10</ack_time>

</comm._action>

</comm._block>
<comm._block>

<comm._action>

<name>SMSName1</name>
<ack_mode>yes</ack_mode>
<ack_time>30</ack_time>

</comm._action>

</comm._block>

</comm._mode>

ILLUSTRATION 1a - Sample XML Delivery Mode Document

<comm._mode>

<comm._block>

<comm._action>

<name>IMName2</name>
<ack_mode>yes</ack_mode>
<ack_time>10</ack_time>

</comm._action>
<comm._action>

<name>EmailName1</name>
<ack_mode>no</ack_mode>

</comm._action>

</comm._block>

</comm._mode>

ILLUSTRATION 1b - Sample XML Delivery Mode Document

<comm._mode>

<comm._block>

<comm._action>

<name>EmailName2</name>
<ack_mode>no</ack_mode>

</comm._action>

</comm._block>

</comm._mode>

ILLUSTRATION 1c - Sample XML Delivery Mode Document

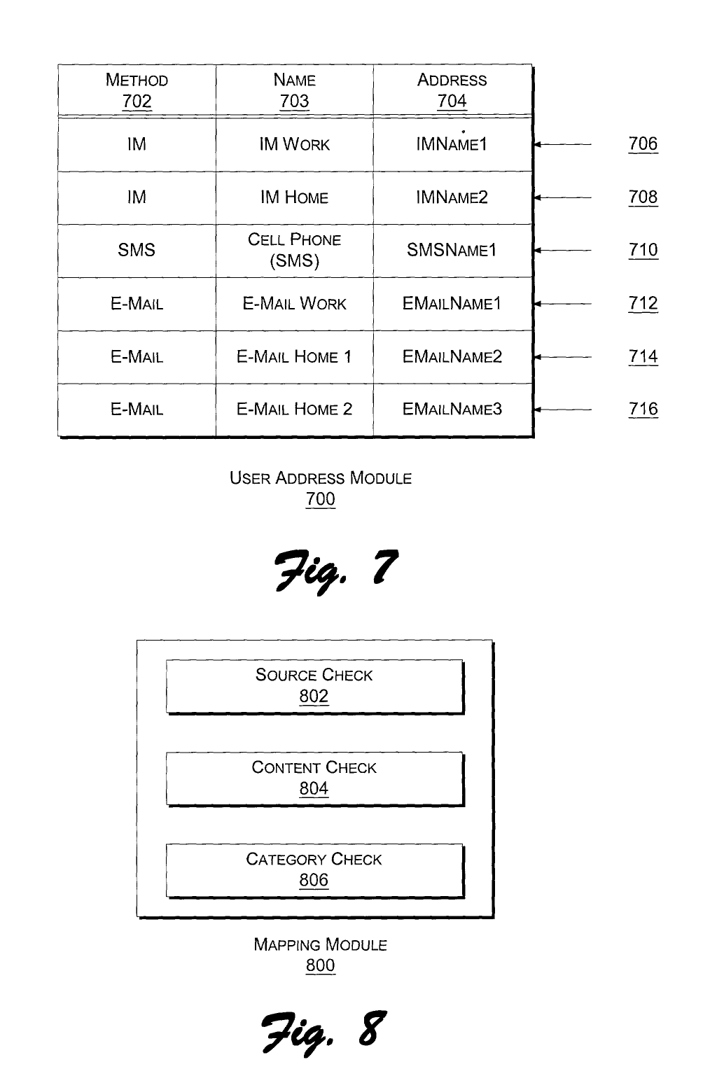

FIG. 7 is a diagram of a user address module 700 similar to the user address module 422 shown in FIG. 4. The user address module 700 is exemplary and is shown for discussion purposes only. Those skilled in the art will recognize that the user address module 700 may be configured differently than as shown herein.

The user address module 700 includes a method column 702, a name column 703 and an address column 704. As previously discussed, the user address module 700 is where a user enters all the addresses to which the user is willing to receive alerts. Each entry to the user address module 700 includes the method (method column 702) used to send an alert to the address listed (address column 704) and a friendly name (name column 703) that identifies the address. In the present example, entry 706 includes an entry in the method column 702 of “IM”, an entry in the name column 703 of “IM Work” and an entry in the address column 704 of “IMName1”. This indicates that the address name “IMName 1” can receive alerts by Instant Messaging, and the friendly name identifies this address as being an Instant Messaging address at the user's place of business. The other entries 708 - 716 contain similar values and it can be seen that the user address module 700 may contain multiple IM address, SMS addresses or E-Mail addresses.

FIG. 8 is a diagram of a mapping module 800 similar to the mapping module 426 shown in FIG. 4. The mapping module 800 of FIG. 8 is exemplary only and those skilled in the art will recognize that the mapping module 800 may be configured in other ways to suit the purposes of the invention(s) described herein.

The mapping module 800 includes a source check module 802, a content check module 804 and a category check module 806. The source check module 802 verifies that an alert was delivered from a valid source specified by the user. This prevents junk messages from being routed to the user via the alert system. The content check module 804 determines the type of content in an alert. For example, if an alert contains home security information, the content check module 804 is configured to recognize this information and handle the alert accordingly. It is noted that either the source check module 802 or the content check module 804 or both may be included in the mapping module 800.

The category check module 806 is configured to determine the appropriate category to which an incoming alert belongs. For example, if the source check module 802 determines that an incoming alert is from a valid source and the content check module 804 determines that the alert is a stock price alert, then the category check module 806 will identify categories in which the alert should be classified. The mapping module 800 and its functions will be discussed in greater detail below.

FIG. 9 is a diagram of a delivery modes module 900 similar to the delivery modes module 424 shown in FIG. 4. It is noted that the delivery modes module 900 of FIG. 9 is exemplary only, and those skilled in the art will recognize that the delivery modes module 900 may be configured in many different ways to accomplish the goals and objectives of the present invention(s).

The delivery modes module 900 may include from one to virtually any number of delivery modes. In the present example, the delivery modes module 900 includes delivery mode A 902, delivery mode B 904 and delivery mode C 906. Each delivery mode 902 - 906 may contain from one to any practical number of delivery blocks, and each block can contain one or more delivery actions. In this example, delivery mode A 902 includes a primary delivery block 907 that includes a first delivery action 909. Delivery mode A 902 also includes a secondary delivery block 908 that includes a first delivery action 910.

Delivery mode B 904 includes a primary delivery block 911 that includes a first delivery action 912 and a second delivery action 914. Delivery mode C 906 includes a primary delivery block 915 that includes a first delivery action 916. Each of the delivery actions 909 - 916 is structured similarly to the delivery action 500 shown in FIG. 5.

As previously mentioned, each category has a delivery mode associated with it. If a category is assigned delivery mode A 902, then delivery mode A 902 is assigned to all alerts associated with the category. Delivery of alerts associated with delivery mode A 902 will be made via the delivery action(s) included in the primary delivery block 907, i.e., the first delivery action 909. It is noted that the alerts will also be delivered via any other designated delivery actions—if present—included in the primary delivery block 907.

The first delivery action 909 of the primary delivery block 907 indicates that an alert assigned to delivery mode A 902 will be delivered by IM to address IMName 1(918). The first delivery action 909 also indicates in an acknowledgment field 920 that an acknowledgement to the response is expected. A time to wait field 922 has the value of 10 (ten), indicating that if an acknowledgement to the alert is not received within ten minutes, the alert delivery is deemed to have failed. As shown in this example, the default time unit is minutes, though a user may set a default time unit to seconds, hours, days, etc.

If the alert delivery fails according to the delivery action(s) 909 of the primary delivery block 907, then the alert will be delivered according to the delivery action(s) 910 of the secondary delivery block 908. The first delivery action 910 of the secondary delivery block 908 indicates that, in the event that the alert was not successfully delivered according to the primary delivery block 907, the alert will be delivered by SMS to address SMSName1 (924). An acknowledgement field 926 in the first delivery action 910 of the secondary delivery block 908 indicates that an acknowledgment to this alert is expected, and a time to wait field 928 indicates that if the acknowledgement is not received within thirty (30) minutes, then the alert delivery via the first delivery action 910 (of the secondary delivery block 908) is deemed to have failed.

In the present example, the delivery modes module 900 also includes delivery mode B 904. Delivery mode B 904 only includes a primary delivery block 911. The primary delivery block 911 includes a first delivery action 912 and a second delivery action 914. Alerts associated with delivery mode B 904 will be delivered according to both the first delivery action 912 and the second delivery action 914.

The first delivery action 912 indicates that an alert assigned to delivery mode B 904 will be delivered by IM to address IMName2 (930). An acknowledgement field 932 in the first delivery action 912 indicates that an acknowledgment to this alert is expected, and a time to wait field 934 indicates that if the acknowledgement is not received within ten (10) minutes, then the alert delivery via the first delivery action 912 is deemed to have failed.

The second delivery action 914 indicates that an alert assigned to delivery mode B 904 will also be delivered by E-Mail to address EMailName1 (936). An acknowledgement field 938 in the second delivery action 914 indicates that an acknowledgment to this alert is NOT expected. As a result a time to wait field 940 is zero (or it may be empty), indicating that a time to wait does not apply. If an error in the delivery of the alert via the second delivery action 914 is received, then the alert delivery via the second delivery action 914 is considered to have failed.

Delivery mode C 906 includes a primary delivery block 915 that has a first delivery action 916. The first delivery action 916 indicates that the alert will be delivered by E-Mail to address EMailName 2 (942). An acknowledgment field 944 indicates that no acknowledgement to the alert is expected and, therefore, the value in a time to wait field 946 is zero. If an error in the delivery of the alert via the first delivery action 916 is received, then the alert delivery via the first delivery action 916 is considered to have failed. However, if this delivery fails, there is no backup (secondary) delivery block. Therefore, for additional reliability, it can be seen that a delivery mode is better suited for alert delivery if it includes a secondary (and, possibly, a tertiary) delivery block.

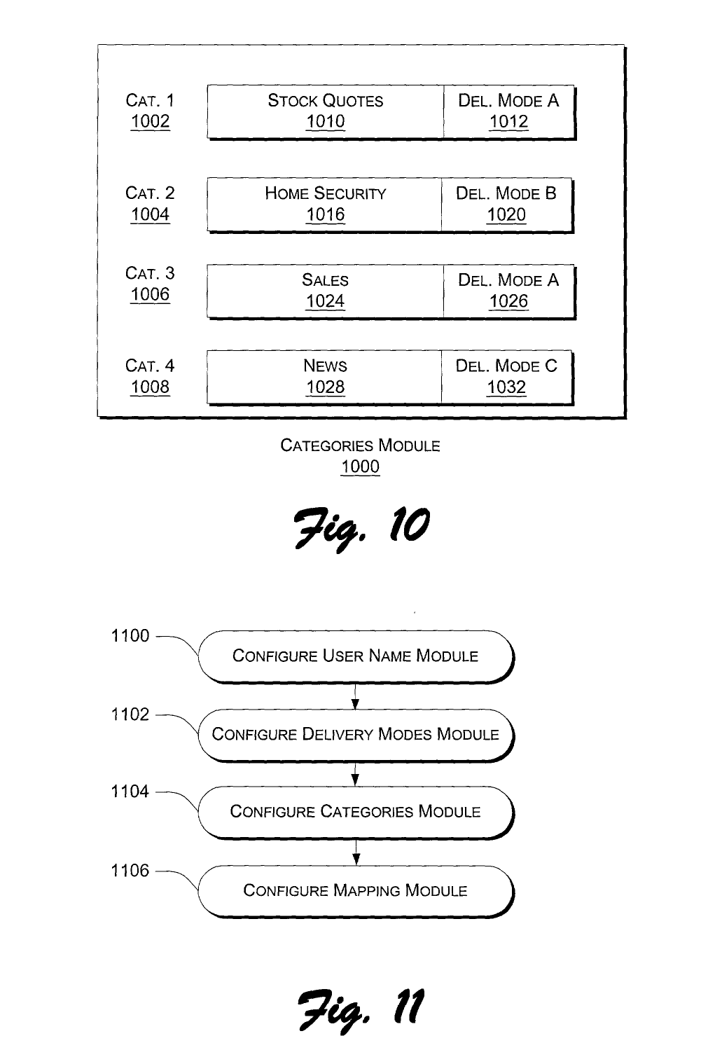

FIG. 10 is a diagram of a categories module 1000 that may be used in the implementations described herein. The categories module 1000 is similar to the categories module 420 shown in FIG. 4. The categories module 1000 is an example of but one implementation that may be used. Those skilled in the art will recognize that many variations on this example may be used.

The categories module 1000 includes category 1 1002, category 2 1004, category 3 1006 and category 4 1008. Each category 1002-1008 includes a category name (1010, 1016, 1024, 1028) and a delivery mode (1012, 1020, 1026, 1032). As previously discussed, each delivery mode (1012-1032) may have one or more delivery blocks and/or actions that determine how alerts are to be delivered in accordance with the delivery mode.

Category 1 1002 is named “Stock Quotes” 1010. Delivery Mode A 1012 is assigned to category 1 1002. Category 2 1004 has a category name of “Home Security” 1016 and has Delivery Mode B 1020 assigned thereto. Category 3 1006 is named “Sales” 1024 and Delivery Mode A 1026 is assigned thereto. Delivery Mode C 1032 is assigned to category 4 1008, which is named “News.” The categories, names and delivery modes are only examples of how categories may be named and how a delivery mode is assigned to each category. The examples given above are not intended to limit the naming of categories or delivery modes as recited in the appended claims.

FIG. 11 is a flow diagram depicting actions taken by a user to configure the alert center program. At block 1100, the user configures the user name module, wherein each address to which the user is willing to receive alerts is entered. At block 1102, the user configures the delivery modes module. This entails creating delivery actions and delivery modes, and assigning one or more delivery actions to each delivery mode. At block 1104, the categories module is configured, wherein categories are created and one or more delivery modes are assigned to each category. Finally, at block 1106, the mapping module is configured, wherein the system is configured to map alerts received from various alert sources to particular categories.

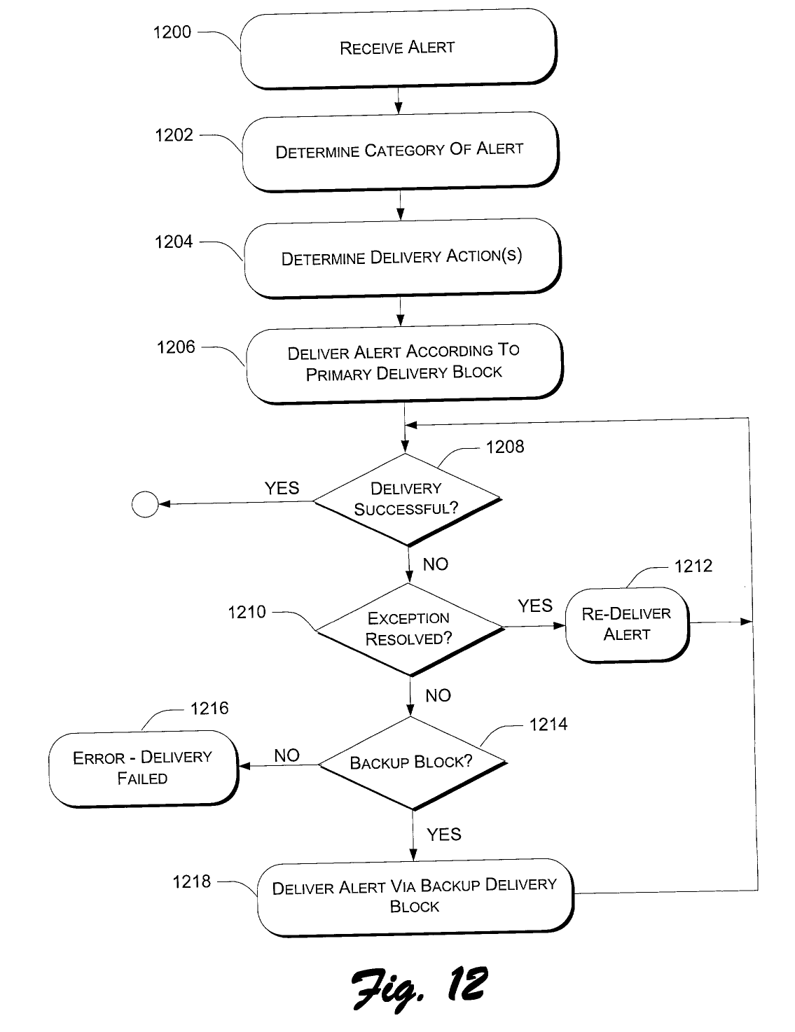

FIG. 12 is a flow diagram that depicts a method of receiving and distributing alerts. Continuing reference will be made to the features and reference numerals of previous figures in the discussion of FIG. 12. At block 1200, an alert is received from one of multiple alert sources. The mapping module 426 (FIG. 4) categorizes the alert at block 1202 according to the source of the alert and the categories module 420 (FIG. 4). The categorization of the alert may be according to the source of the alert, the content of the alert, the source and the content, or any other feature of the alert that may be used to classify alerts for priority distribution. For this example, the alerts are categorized on the basis of the source of the alert.

At block 1204, the mapping module 426 (FIG. 4) determines a primary delivery mode for the alert from the category with which the alert is associated. Once the delivery mode is determined, the alert is delivered at block 1206. If the delivery is successful (“Yes” branch, block 1208), then the process is complete. A delivery is considered to be successful if an acknowledgement is received to an alert to which an acknowledgement is expected within a specified time, or if no errors are received to an alert to which an acknowledgement is not expected. If, however, the delivery is not successful (“No” branch, block 1208), then an attempt is made to resolve the exception. If the exception is resolved (“Yes” branch, block 1210), then an attempt is made to re-deliver the alert at block 1212. If the re-delivery is successful (“Yes” branch, block 1208), then the process terminates successfully.

If an exception cannot be resolved (“No” branch, step 1210), then an attempt is made to deliver the alert via a backup mode. If there is a backup mode specified for the delivery mode (“Yes” branch, block 1214), then the alert is delivered via the backup mode at block 1218. If the backup delivery is successful (“Yes” branch, block 1208), then the process terminates successfully. If not (“No” branch, block 1208), then the process repeats to attempt to resolve an encountered exception or to delivery the alert via another backup delivery mode. If no backup mode is specified for the category of alert (“No” branch, block 1214), then an error message that the delivery of the alert failed is generated at block 1216. The process is configured to repeat until the alert is successfully delivered by one of the delivery modes of the category associated with the alert, or until all available delivery modes have been attempted and have failed.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method, comprising:
receiving an alert for a user from one of multiple alert sources;
mapping the alert to a delivery mode; and
transmitting the alert to the user according to the specified delivery mode.

2. The method as recited in claim 1, wherein mapping the alert further comprises mapping the alert according to the source of the alert.

3. The method as recited in claim 1, wherein mapping the alert further comprises mapping the alert according to alert content.

4. The method as recited in claim 1, wherein the delivery mode specifies a delivery method used to deliver the alert and wherein the transmitting further comprises transmitting the alert to the user via the delivery method indicated in the delivery mode.

5. The method as recited in claim 1, wherein the delivery mode specifies a delivery action that indicates a delivery method to be used to deliver the alert and whether an acknowledgement to the alert should be expected, and the method further comprises waiting for an acknowledgement to the alert if the delivery mode indicates that an acknowledgement to the alert should be expected.

6. The method as recited in claim 5, wherein the delivery action specifies a time period to wait for an acknowledgement if an acknowledgement to the alert is expected, and wherein the waiting further comprises waiting the specified time period for an acknowledgement to the alert.

7. The method as recited in claim 1, wherein:
the delivery mode further specifies a first delivery method used to deliver the alert;
the delivery mode further specifies a second delivery method used to deliver the alert; and
the transmitting further comprises transmitting the alert to the user via the first delivery method and the second delivery method as indicated by the delivery mode.

8. The method as recited in claim 1, wherein the mapping further comprises:
defining one or more categories of alerts;
assigning a delivery mode to each category; and
categorizing the alert, thereby mapping the alert to the delivery mode of the category.

9. The method as recited in claim 8, further comprising assigning a priority to each category, and wherein the assigning a delivery mode further comprises assigning a delivery mode to a category based on the priority assigned to the category.

10. The method as recited in claim 1, wherein:
the delivery mode further comprises a primary delivery block specifying at least one delivery action, and a secondary delivery block specifying at least one delivery action;
the mapping the alert to a delivery mode further comprises mapping the alert to the delivery action specified in the primary delivery block and mapping the alert to the delivery action specified in the secondary delivery block; and
transmitting the alert to the user according to the delivery action specified in the secondary delivery block if transmitting the alert to the user according to the delivery action specified in the primary delivery block is unsuccessful.

11. The method as recited in claim 10, wherein the delivery actions specified in the primary delivery block and the secondary delivery block indicate a delivery method to be used to deliver the alert and whether an acknowledgement to the alert should be expected, and the method further comprises:
waiting for an acknowledgement to the transmission of the alert according to the delivery action of the primary delivery block if the delivery action of the primary delivery block indicates that an acknowledgement to the alert should be expected; and
waiting for an acknowledgement to the transmission of the alert according to the delivery action of the secondary delivery block if the delivery action of the secondary delivery block indicates that an acknowledgement to the alert should be expected, provided the alert is transmitted according to the secondary delivery block.

12. The method as recited in claim 10, wherein:
the primary delivery block specifies a first delivery action that indicates a first delivery method and a second delivery action that indicates a second delivery method;
the transmitting the alert to the user according to the delivery action specified in the secondary delivery block further comprises transmitting the alert to the user according to the delivery action specified in the secondary delivery block if either the first delivery method indicated in the first delivery action of the primary delivery block, or the second delivery method indicated in the second delivery action of the primary delivery block fails to result in transmission of the alert to the user.

13. The method as recited in claim 10, wherein: each delivery action further comprises:
a delivery method to be used to deliver the alert;
whether an acknowledgement to the alert should be expected;
a time period to wait for an acknowledgement if an acknowledgement to the alert is expected; and the method further comprises:
waiting for an acknowledgement to the transmission of the alert according to the delivery action of the primary delivery block if the delivery action indicates that an acknowledgement to the alert is expected; and
waiting for an acknowledgement to the transmission of the alert according to the delivery action of the secondary delivery block if the delivery action indicates that an acknowledgement to the alert is expected, provided that the alert was transmitted according to the secondary delivery block.

14. The method as recited in claim 10, wherein the primary delivery block and the secondary delivery block each specify a first delivery action that indicates a first delivery method to be used to deliver the alert and whether an acknowledgement to the alert should be expected, and a second delivery action that indicates a second delivery method to be used to deliver the alert and whether an acknowledgement to the alert should be expected, the method further comprising:
waiting for an acknowledgement to the transmission of the alert according to each delivery action of the primary delivery block that indicates that an acknowledgement to the alert should be expected; and
waiting for an acknowledgement to the transmission of the alert according to each delivery action of the secondary delivery block that indicates that an acknowledgement to the alert should be expected, provided the alert is transmitted according to the delivery actions of the secondary delivery block.

15. The method as recited in claim 14, wherein each delivery action that indicates to wait for an acknowledgement specifies a time period to wait for an acknowledgement, and wherein waiting for an acknowledgement further comprises waiting the specified time period for an acknowledgement.

16. A centralized alert delivery system, comprising:
an input/output (I/O) module configured to receive alerts from multiple alert sources;
a mapping module configured to map an alert to a delivery mode; and
a communications layer that interfaces to one or more communications modules, the communications layer being configured to receive the mapped alert and deliver the alert via a communications module according to the delivery mode associated with the alert.

17. The centralized alert delivery system as recited in claim 16, wherein the mapping module is further configured to map the alert according to the source of the alert.

18. The centralized alert delivery system as recited in claim 16, wherein the alert further comprises content, and wherein the mapping module is further configured to map the alert according to the content of the alert.

19. The centralized alert delivery system as recited in claim 16, wherein the delivery mode specifies a delivery action that indicates a delivery method by which an alert associated with the delivery mode is transmitted.

20. The centralized alert delivery system as recited in claim 19, wherein the delivery method is chosen from one of the following delivery methods: e-mail, instant messaging, SMS (short message service) messaging.

21. The centralized alert delivery system as recited in claim 16, wherein the delivery mode further comprises one or more delivery blocks, each delivery block including one or more delivery actions, each delivery action specifying:
a delivery method by which an alert associated with the delivery mode is transmitted;
whether an acknowledgement to the alert is expected; and
if an acknowledgement to the alert is expected, a time to wait for the acknowledgement.

22. The centralized alert delivery system as recited in claim 16, wherein the delivery mode further comprises one or more delivery blocks, each delivery block including one or more delivery actions, each delivery action specifying a delivery method by which the associated alert is transmitted and whether an acknowledgement to the transmitted alert is expected.

23. The centralized alert delivery system as recited in claim 22, wherein each delivery action that indicates an acknowledgement is expected further specifies a time to wait for the acknowledgement.

24. The centralized alert delivery system as recited in claim 16, wherein:
the delivery mode further comprises a primary delivery block and a secondary delivery block; and
the communications layer is further configured to deliver the alert via the one or more communications modules according to a delivery method specified in the primary delivery block and, if delivery according to the primary delivery block fails, to deliver the alert according to a delivery method specified in the secondary delivery block.

25. The centralized alert delivery system as recited in claim 16, wherein:
the delivery mode further comprises a primary delivery block that includes a first delivery action that specifies a delivery method and a second delivery action that specifies a delivery method; and
the communications layer is further configured to deliver the alert via the one or more communications modules according to the delivery method specified in the first delivery action and according to the delivery method specified in the second delivery action.

26. The centralized alert delivery system as recited in claim 25, wherein:
the delivery mode further comprises a secondary delivery block; and
the communications layer is further configured to delivery the alert via the one or more communications modules according to a delivery method specified in the secondary delivery block if the delivery of the alert according to either the first delivery action or the second delivery action in the primary delivery block fails.

27. The centralized alert delivery system as recited in claim 16, further comprising a categories module that identifies categories into an alert may be categorized, wherein each category has an associated delivery mode; and
the mapping module is further configured to categorize the alert into a category identified in the categories module thereby associating the alert with the delivery mode of the category.

28. A computer system, comprising:
a processor;
an I/O module;
memory; and
an alert center stored in the memory, the alert center including:
a subscription layer configured to receive an alert from an alert source and assign a delivery mode to the alert; and
a communications layer configured to transmit the alert according to a delivery mode assigned to the alert.

29. The computer system as recited in claim 28, wherein the alert center is further configured to monitor for an acknowledgement that the alert was successfully delivered.

30. The computer system as recited in claim 28, wherein the alert center is further configured to monitor for an acknowledgement that the alert was successfully delivered and, if an acknowledgment is not received within a specified time period, assign a backup delivery method to the alert and attempt to deliver the alert according to the backup delivery method.

31. The computer system as recited in claim 28, wherein:
the delivery mode further comprises a primary delivery block having a first delivery action and a second delivery action; and
the communications layer is further configured to transmit the alert according to the first delivery action and the second delivery action of the primary delivery block.

32. The computer system as recited in claim 31, wherein:
the delivery mode further comprises a primary delivery block having a delivery action and a secondary delivery block having a delivery action; and
the communications layer is further configured to transmit the alert according to the delivery action of the primary delivery block and, if delivery of the alert according to the primary delivery block fails, to transmit the alert according to the delivery action of the secondary delivery block.

33. The computer system as recited in claim 31, wherein:
the delivery action of the primary delivery block is a first delivery action;
the primary delivery block further comprises a second delivery action;
the first delivery action and the second delivery action further comprise a time to wait for an acknowledgement that the alert was received; and
the communications layer is further configured to transmit the alert according to the delivery action of the secondary delivery block if an acknowledgement to the transmission of the alert according to the first delivery action or the second delivery action of the primary delivery block is not received with the time to wait identified by the first delivery action and the second delivery action, respectively.

34. The computer system as recited in claim 28, wherein:
the subscription layer further comprises a categories module that includes one or more categories into which an alert may be categorized, each category having a delivery mode associated therewith; and
the subscription layer further comprises a mapping module configured to categorize an alert received from an alert source, thereby associating the delivery mode of the category with the alert.

35. One or more computer-readable media containing computer-executable instructions that, when executed on a computer, perform the following:
receiving an alert from one of a plurality of alert sources;
determining a delivery mode which specifies a delivery method by which the alert should be forwarded to a user;
transmitting the alert to the user according to the delivery mode.

36. The one or more computer-readable media as recited in claim 35, wherein the determining a primary delivery mode further comprises:
determining the alert source from which the alert originated;
identifying a category associated with the alert source; and
identifying a delivery mode associated with the category.

37. The one or more computer-readable media as recited in claim 35, wherein the transmitting the alert further comprises:
identifying a delivery action associated with the delivery mode; and
transmitting the alert according to the delivery action.

38. The one or more computer-readable media as recited in claim 35, wherein the transmitting the alert further comprises:
identifying a first delivery action associated with the delivery mode;
identifying a second delivery action associated with the delivery mode; and
transmitting the alert according to the first delivery action and the second delivery action.

39. The one or more computer-readable media as recited in claim 35, wherein:
the delivery mode further comprises a primary delivery block that specifies one or more delivery actions, and a secondary delivery block that specifies one or more delivery actions; and
the transmitting the alert to the user according to the delivery mode further comprises transmitting the alert to the user according to the delivery action of the primary delivery block and, if the transmission fails, transmitting the alert to the user according to the delivery action of the secondary delivery block.

40. The one or more computer-readable media as recited in claim 39, wherein:
the primary delivery mode includes more than one delivery action; and
the transmission of the alert according to the primary delivery block is deemed to fail if the transmission of the alert according to the first or second delivery actions fails.

41. The one or more computer-readable media as recited in claim 39, wherein:
the primary delivery mode includes more than one delivery action; and
the transmission of the alert according to the primary delivery block is deemed to fail if the transmission of the alert according to both the first and second delivery actions fails.

42. The one or more computer-readable media as recited in claim 35, further comprising monitoring for an acknowledgement that the alert was successfully received by the user.
